(19) United States
(12) Patent Application Publication
(10) Pub. No.: US 2011/0199390 A1
(43) Pub. Date: Aug. 18, 2011

(54) MEDICAL DIAGNOSIS SUPPORT APPARATUS, METHOD OF CONTROLLING MEDICAL DIAGNOSIS SUPPORT APPARATUS, AND PROGRAM

(75) Inventors: Yoshio Iizuka, Yokohama-shi (JP); Masaaki Imaizumi, Tokyo (JP); Kiyohide Satoh, Kawasaki-shi (JP); Masami Kawagishi, Yokohama-shi (JP)

(73) Assignee: CANON KABUSHIKI KAISHA, Tokyo (JP)

(21) Appl. No.: 13/124,551

(22) PCT Filed: Jul. 23, 2010
(86) PCT No.: PCT/JP2010/062965

§ 371 Date: Apr. 15, 2011

(30) Foreign Application Priority Data
Aug. 10, 2009 (JP) 2009-186153

(51) Int. Cl. G09G 5/00

(52) U.S. Cl. 345/629

(57) ABSTRACT

A medical diagnosis support apparatus includes an item display unit which displays, on a display, a plurality of items for which a parameter for deriving diagnosis support information can be input, a temporary input unit which inputs a plurality of different values as temporary input values for the plurality of items displayed by the item display unit, a deriving unit which derives, by referring to medical information, a plurality of pieces of diagnosis support information each corresponding to one of combinations of the plurality of different temporary input values, and a presenting unit which presents, on the display, the plurality of pieces of diagnosis support information derived by the deriving unit, together with the display of the plurality of items, in a list format.

### TECHNICAL FIELD

The present invention relates to a medical diagnosis support apparatus for supporting medical diagnoses, a method of controlling the medical diagnosis support apparatus, and a program.

### BACKGROUND ART

Recently, shortages in doctors is becoming a more serious issue in many medical departments, and the necessity for a medical diagnosis support apparatus that reduces the load on a doctor in medical diagnoses is increasing. To meet this need, computer-aided diagnosis (CAD) techniques have been researched and developed. The CAD techniques include a technique (abnormality detection support technique) that supports the detection of an abnormal lesion, a technique (differential diagnosis support technique) to infer the most possible diagnosis name, and an interpretation report formation support technique.

The differential diagnosis support technique is a technique that supports a differential diagnosis by a doctor. An example is a technique by which the feature (interpretation finding) of an abnormal lesion extracted from a medical image by a doctor is used as input information, and the nature of the lesion (for example, whether the lesion is malignant or benign) is inferred and presented. For example, patent reference 1 has proposed a method of diagnosing a most possible disease name from a plurality of predetermined disease names, when a user inputs previously manually obtained information expressed as a numerical value to a neural network. The previously manually obtained information herein mentioned contains the clinical parameter of a patient and the descriptor of a radiograph. The clinical parameter is the attribute information or laboratory test information of a patient and is an objectively measured value, so a doctor does not hesitate to select a value. The descriptor of a radiograph is a finding described by a doctor in an image diagnosis. The finding can be decomposed into constituent elements, that is, what (a finding item) and how (the value of the finding item). In patent reference 1, finding items are predetermined, and a doctor describes (inputs) the values of the finding items. In this case, the doctor sometimes hesitates to select the value of a finding item.

On the other hand, the interpretation report formation support technique is a support technique for allowing a doctor to easily and efficiently form a report. A technique of increasing the efficiency of the input of a finding as the major part of an interpretation report is particularly important. In the conventional interpretation report system, a doctor inputs a finding in a free text form by typing a keyboard. Alternatively, a computer automatically recognizes a speech uttered toward a microphone by a doctor, and outputs, to a finding entry field, the recognition result as a finding in a free text form. Unfortunately, the automatic speech recognition result often contains errors. To correct the errors, therefore, the doctor must edit the finding in a free text form by typing a keyboard. Also, doctors can use different terms, different grammars, and different styles when they input findings in a free text form. This makes it very difficult for a computer to automatically analyze findings. Accordingly, it is difficult to statistically analyze an interpretation report and extract a new medical knowledge, or efficiently form a new interpretation report by reusing a past interpretation report.

To break down the circumstances as described above, the standardization of medical terms including finding terms and the standardization of the document structures of interpretation reports and the like are being advanced. A template input method is suited to forming a document having a structure complying with the standards by using only terms complying with the standards. That is, finding items and possible values of the finding items are defined as a finding template beforehand, and a doctor inputs a finding by selecting an appropriate finding item and its value from the finding template. Inputting a finding by using the template input method allows a computer to readily automatically analyze the finding.

The template input method has already been used in, for example, test reports of health examination. Also, the template input method can widely spread in the future with the advance of the standardization of interpretation reports.

### PRIOR ART REFERENCE

[Patent Reference 1] Japanese Patent Laid-Open No. 4-332548

Unfortunately, a doctor sometimes hesitates to input a finding because an image to be diagnosed is unclear or the doctor can interpret an abnormal lesion of interest in a plurality of ways. When describing findings in a free text form, a doctor can vaguely describe a finding which he or she hesitates to judge. Since, however, a vague description cannot be useful information for readers, it is necessary to describe a finding as clearly as possible. In addition, when using the template input method as an interpretation report formation method, a doctor must select only one value defined in the finding template even for a finding which he or she hesitates to judge.

In patent reference 1, no highly possible disease name is output unless a doctor inputs the value of a finding item. Even when the doctor hesitates to select the value of the finding item, therefore, he or she must select one value of the finding item without any support from the diagnosis support apparatus. The user (doctor) can, of course, change the values of a finding item one at a time, and check the result of inference by the apparatus for each value, thereby checking the effects of the value changes on the inference results one by one. However, in the operation of changing the values and checking the inference results one by one as described above, a human error due to a slip of memory readily occurs. Furthermore, if many combinations of values to be changed exist, it is very cumbersome for the user to try all the combinations of values. This makes the method less practical in a medical diagnosis support apparatus for which the work efficiency is important.

Accordingly, the above-described prior art has not provided any support function which, when a doctor hesitates to select an optimum value of a finding item to be input, allows the doctor to select an optimum value by an efficient method capable of reducing errors.

### SUMMARY OF INVENTION

The present invention provides a medical diagnosis support technique by which even when a doctor hesitates to select an optimum value of a finding item to be input during a medical diagnosis, he or she can simultaneously temporarily input a plurality of values of the finding item, and readily understand the effect of each temporary input value on diagnosis support information.

According to one aspect of the present invention, there is provided a medical diagnosis support apparatus comprising: item display means for displaying, on display means, a plurality of items for which a parameter for deriving diagnosis support information can be input; temporary input means configured to input a plurality of different values as temporary input values for the plurality of items displayed by the item display means; deriving means for deriving, by referring to medical information, a plurality of pieces of diagnosis support information each corresponding to one of combinations of the plurality of different temporary input values input by the temporary input means; and presenting means for presenting, on the display means, the plurality of pieces of diagnosis support information derived by the deriving means, together with the display of the plurality of items, in a list format.

According to an aspect of the present invention, the user (doctor) can simultaneously temporarily input a plurality of values of a finding item which he or she hesitates to judge, and readily understand, in the form of a list, the effect of each temporary input value on diagnosis support information. Therefore, the doctor can determine an optimum value of the finding item by an efficient method capable of reducing errors.

According to another aspect of the present invention, one of a plurality of temporary input values can be changed into a final input value by selecting one of a plurality of pieces of presented diagnosis support information. This makes extremely easy selection of an optimum value possible.

Further features of the present invention will become apparent from the following description of exemplary embodiments (with reference to the attached drawings).

### BRIEF DESCRIPTION OF DRAWINGS

FIG. 1 is a view showing an example of the device configuration of a medical diagnosis support apparatus according to the first embodiment;

FIG. 2 is a flowchart showing the control procedure of the medical diagnosis support apparatus according to the first embodiment;

FIG. 3 is a flowchart showing the procedure of the process of deriving a plurality of pieces of diagnosis support information;

FIG. 4A is a view showing a first operation window example for explaining a finding temporary input means, FIG. 4B is a view showing the list of final input findings and temporary input findings obtained by the process shown in FIG. 4A, and FIG. 4C is an exemplary view showing a plurality of pieces of diagnosis support information derived by using final input values and temporary input values shown in FIG. 4B;

FIG. 5A is a view showing a second operation window example for explaining the finding temporary input means, and FIG. 5B is a view showing the list of final input findings and temporary input findings obtained by the process shown in FIG. 5A;

FIG. 6A is a view showing a third operation window example for explaining the finding temporary input means, and FIG. 6B is a view showing the list of final input findings and temporary input findings obtained by the process shown in FIG. 6A;

FIG. 7A is a view showing a fourth operation window example for explaining the finding temporary input means, and FIG. 7B is a view showing the list of final input findings and temporary input findings obtained by the process shown in FIG. 7A;

FIG. 8A is a view showing a fifth operation window example of the medical diagnosis support apparatus according to the present invention, FIG. 8B is a view showing a sixth operation window example of the medical diagnosis support apparatus according to the present invention, FIG. 8C is a view showing a seventh operation window example of the medical diagnosis support apparatus according to the present invention, and FIG. 8D is a view showing an eighth operation window example of the medical diagnosis support apparatus according to the present invention; and

FIG. 9A is an exemplary view showing a first display method (operation window) that replaces a FIG. 805, FIG. 9B is an exemplary view showing a second display method (operation window) that replaces the FIG. 805, FIG. 9C is an exemplary view showing a third display method (operation window) that replaces the FIG. 805, and FIG. 9D is an exemplary view showing a fourth display method (operation window) that replaces the FIG. 805.

### DESCRIPTION OF EMBODIMENTS

Embodiments of a medical diagnosis support apparatus and a method of controlling the same according to the present invention will be explained below with reference to the accompanying drawings. However, the scope of the invention is not limited to examples shown in the drawings.

### First Embodiment

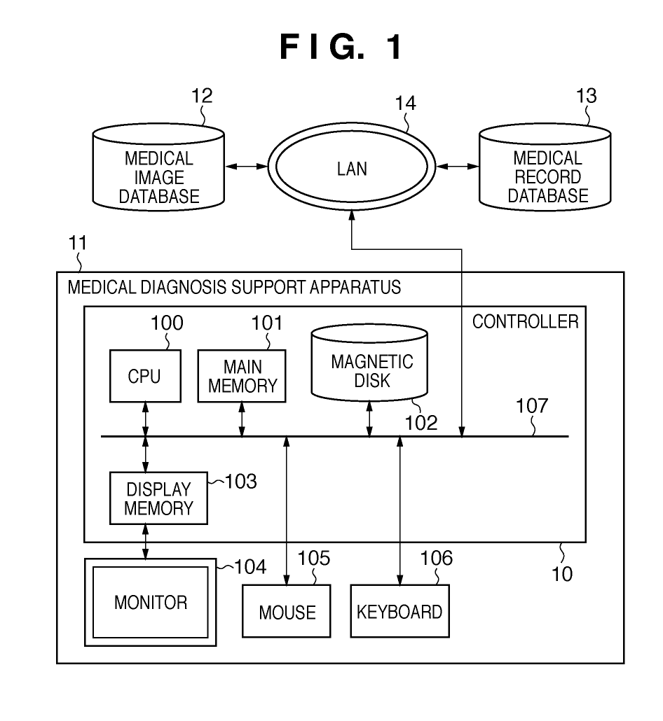

An example of the device configuration of a medical diagnosis support apparatus according to the first embodiment will be explained below with reference to FIG. 1. A medical diagnosis support apparatus 11 has both a finding input support function (interpretation report formation support function), and a differential diagnosis support function. The medical diagnosis support apparatus 11 includes a controller 10, display unit (monitor 104), mouse 105, and keyboard 106. The controller 10 includes a central processing unit (CPU) 100, main memory 101, magnetic disk 102, and display memory 103 connected to each other by a common bus 107. The CPU 100 executes various kinds of control, for example, the control of communication with a medical image database 12 and medical record database 13, and the overall control of the medical diagnosis support apparatus 11, by executing programs stored in the main memory 101.

The CPU 100 mainly controls the operation of each constituent component of the medical diagnosis support apparatus 11. The main memory 101 stores the control programs to be executed by the CPU 100, and provides a work area when the CPU 100 executes the programs. The magnetic disk 102 stores, for example, the operating system (OS), the device drivers of peripheral devices, and various kinds of application software including a program for performing a diagnosis support process (to be described later) or the like. The display memory 103 temporarily stores data to be displayed on the monitor 104. The monitor 104 is, for example, a CRT monitor or liquid crystal monitor, and displays images based on the data from the display memory 103. The mouse 105 and keyboard 106 are respectively used by the user (doctor) to perform pointing input, character input, and the like. The common bus 107 connects the above-mentioned constituent components so that they can communicate with each other.

In this embodiment, the medical diagnosis support apparatus 11 can read out image data from the medical image database 12 and medical record data from the medical record database 13 across a LAN (Local Area Network) 14. The existing PACS (Picture Archiving and Communication System) can be used as the medical image database 12. Also, an electronic medical chart system as a sub-system of the existing HIS (Hospital Information System) can be used as the medical record database 13. Alternatively, it is possible to connect an external memory such as an FDD, HDD, CD drive, DVD drive, MO drive, or ZIP drive to the medical diagnosis support apparatus 11, and load image data and medical record data from the drive.

Note that examples of the types of medical images are a simple X-ray image, X-ray CT image, MRI image, PET image, SPECT image, and ultrasonic image. The medical record data contains, for example, the personal information (for example, the name, birth year/date, age, and sex) and the clinical information (for example, the test value, chief complaint, medical history, and treatment history) of a patient, information for referring to the image data stored in the medical image database 12, and finding information formed by a doctor in charge. In addition, a determined diagnosis name is stored in the medical record data when the diagnosis has advanced.

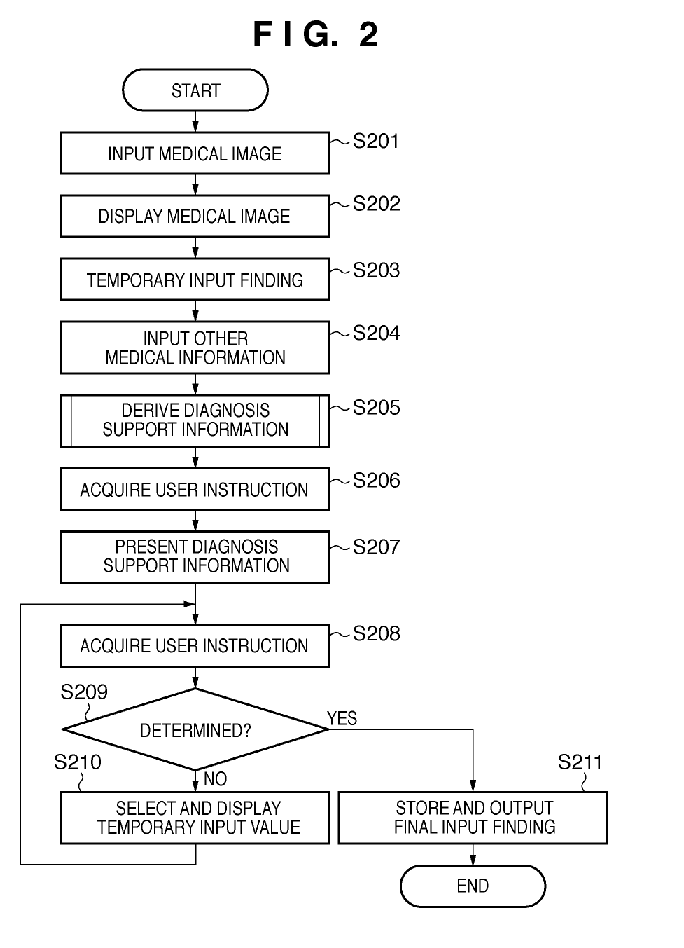

Next, the way the controller 10 controls the medical diagnosis support apparatus 11 will be explained below with reference to FIG. 2. The process shown in FIG. 2 is implemented by the CPU 100 by executing the programs stored in the main memory 101. In step S201, the CPU 100 inputs medical image data (to be referred to as “a diagnosis target image” hereinafter) to the medical diagnosis support apparatus 11 in accordance with input from the mouse 105 and keyboard 106. More specifically, the CPU 100 inputs a medical image by receiving specific medical image data as a diagnosis target image from the medical image database 12 across the LAN 14. Alternatively, the CPU 100 inputs a medical image by reading out specific medical image data as a diagnosis target image from an external memory connected to the medical diagnosis support apparatus 11.

In step S202, the CPU 100 displays the diagnosis target image input to the medical diagnosis support apparatus 11 on the monitor 104.

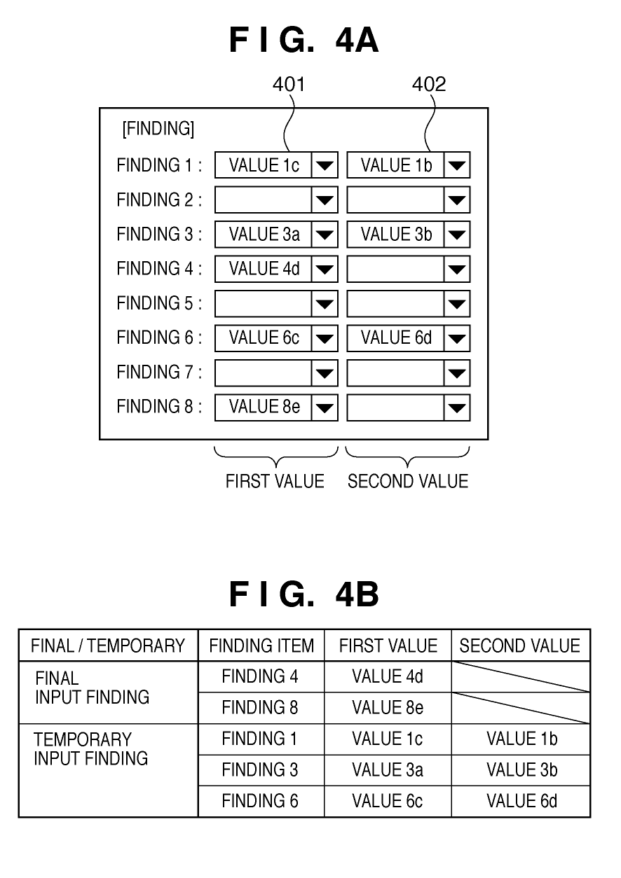

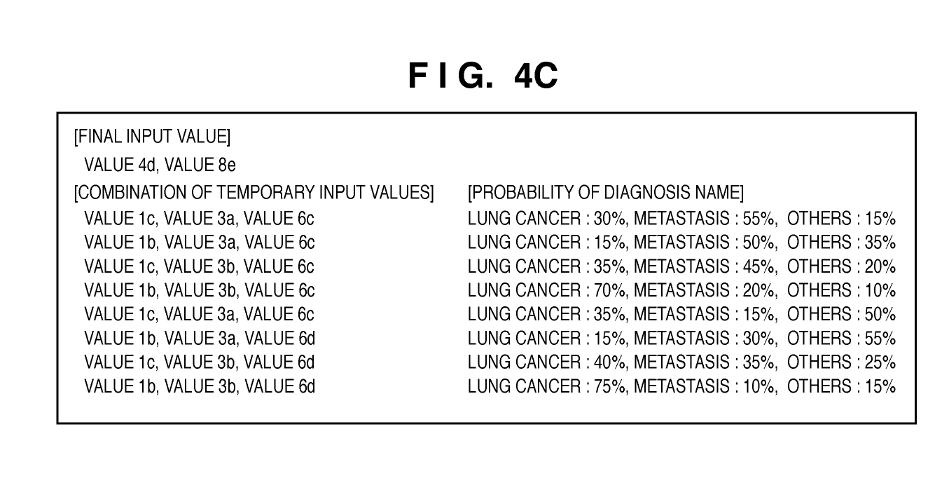

In step S203, the CPU 100 stores, in the main memory 101, provisional findings input by the user (doctor) by using the mouse 105 and keyboard 106 while monitoring the diagnosis target image displayed on the monitor 104, as temporary input findings. The finding temporary input process in this step can be implemented by using one of finding temporary input means using template input methods to be explained below with reference to FIGS. 4A to 4C to FIGS. 7A and 7B.

FIGS. 4A to 4C to FIGS. 7A and 7B will be explained below. These drawings are exemplary views each showing a portion of an operation window displayed on the monitor 104 under the control of the CPU 100. To facilitate the understanding of the following explanation, the number of finding items is eight (findings 1 to 8), and the number of possible values of each finding item is five (choices a to e). However, the present invention is not limited to any specific number of finding items and any specific number of values (choices). Also, the following explanation takes, as an example, an operation window using various controls used in a general OS (Operating System). However, the present invention is not limited to any specific OS and any specific window configuration. Note that “a control” is a constituent part of the operation window and has a function of inputting or selecting a value for a data item. The CPU 100 functions as an item display means for causing the monitor 104 to display at least one item for which a parameter (to be also referred to as “a value” hereinafter) for deriving diagnosis support information can be input.

A first operation window example that functions as the finding temporary input means will be explained below with reference to FIG. 4A. Referring to FIG. 4A, combo boxes 401 and 402 are controls for respectively inputting the first and second values of finding 1. In the initial state, NULL (an invalid value) is set in each combo box. This similarly applies to findings 2 to 8. Since a method of operating a combo box is generally known, an explanation of the method will be omitted.

In FIG. 4A, the user (doctor) inputs a value for only a finding presumably requiring input, while monitoring an abnormal lesion in a diagnosis target image. Also, if the user (doctor) hesitates to select a value when inputting a value for each finding, he or she can simultaneously input the first and second values. On the other hand, the user (doctor) need only input the first value if he or she has no hesitation in value selection. In the example shown in FIG. 4A, the user (doctor) inputs the first and second values for findings 1, 3, and 6 because he or she has hesitation, but inputs only the first value for findings 4 and 8 because he or she has no hesitation. The user (doctor) determines that no value need be input for findings 2, 5, and 7. The CPU 100 checks the input state of each combo box, and stores the first value as a final input value in the main memory 101 for a finding for which only the first value is input. For a finding for which both the first and second values are input, the CPU 100 stores both the first and second values as temporary input values in the main memory 101.

FIG. 4B is an exemplary view showing the display of final input findings and temporary input findings in a list format to be stored in the main memory 101 as the results of the processing in step S203 when the user (doctor) performs the input explained with reference to FIG. 4A. Since each final input finding has only the first value, the second value field is invalid.

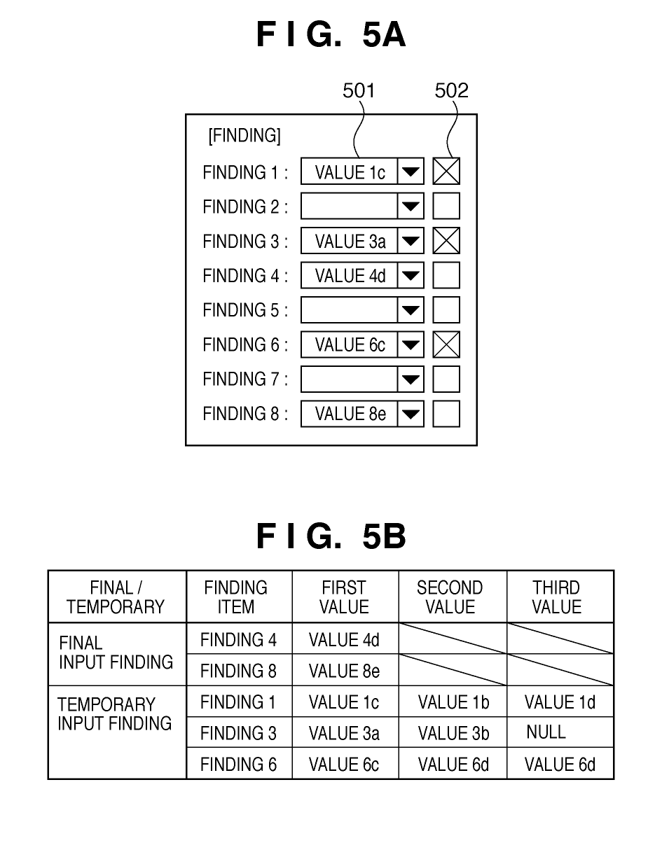

A second operation window example that functions as the finding temporary input means will be explained below with reference FIG. 5A. Referring to FIG. 5A, a combo box 501 is a control for inputting a value for finding 1, and NULL is set in the initial state. On the other hand, a check box 502 is a control to be checked when the user (doctor) hesitates to select a value for finding 1, and 0 (no check) is set in the initial state. This similarly applies to findings 2 to 8. Since a method of operating a combo box and check box is generally known, an explanation of the method will be omitted.

In FIG. 5A, the user (doctor) inputs a value for only a finding presumably requiring input. Also, the user (doctor) checks the check box only when he or she hesitates to select a value when inputting the value of each finding. In the example shown in FIG. 5A, the user (doctor) checks the check boxes of findings 1, 3, and 6 because he or she has hesitation, but does not check the check boxes of findings 4 and 8 because he or she has no hesitation.

The CPU 100 checks the input state of each combo box and the check state of each check box. For a finding for which a value is input in the combo box and the check box is not checked, the CPU 100 stores the value input in the combo box as a final input value in the main memory 101. For a finding for which a value is input in the combo box and the check box is checked, the CPU 100 stores the value input in the combo box and values before and after the input value as temporary input values in the main memory 101. In the example of finding 1 shown in FIG. 5A, the value input in the combo box is value 1c, so the values before and after the input value are values 1b and 1d, and values 1b and 1d are the temporary input values. When the value input in the combo box is value a (the first choice), no value exists before value a, so the values before and after the input value are NULL and value 1b. Similarly, when the value input in the combo box is value 1e (the last choice), no value exists after value 1e, so the values before and after the input value are value 1d and NULL.

FIG. 5B is an exemplary view showing the display of final input findings and temporary input findings in a list format to be stored in the main memory 101 as the results of the processing in step S203 when the user (doctor) performs the input explained with reference to FIG. 5A. Since the final input finding of each of findings 4 and 8 has only the first value, the second value field and third value field are invalid. For each of findings 1, 3, and 6, the second and third values are set as temporary input findings.

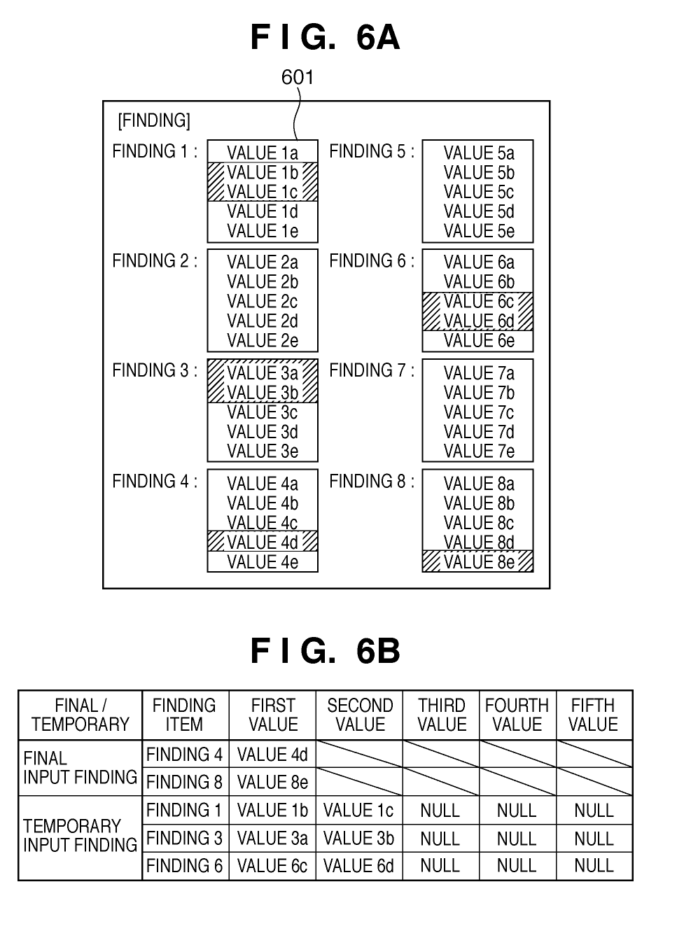

A third operation window example that functions as the finding temporary input means will be explained below with reference to FIG. 6A. Referring to FIG. 6A, a list box 601 is a control for inputting a value for finding 1, and a plurality of values are simultaneously selectable. This similarly applies to findings 2 to 8. Since a method of operating a list box in which a plurality of values are selectable is generally known, an explanation of the method will be omitted.

In FIG. 6A, the user (doctor) inputs a value for only a finding presumably requiring input. Also, the user (doctor) can select two or more values if he or she hesitates to select a value when inputting the value of each finding. The user (doctor) need only select one value if he or she has no hesitation in value selection. In the example shown in FIG. 6A, the user (doctor) selects two values for each of findings 1, 3, and 6 because he or she has hesitation, and selects only one value for each of findings 4 and 8 because he or she has no hesitation.

The CPU 100 checks the selection state of each list box. For a finding for which only one value is selected, the CPU 100 stores the selected value as a final input value in the main memory 101. For a finding for which two or more values are selected, the CPU 100 stores all the selected values as temporary input values in the main memory 101. Note that the temporary input values selected in the list box need only be set as the first value, the second value, . . . , in order from the one selected earliest. It is also possible to determine the first value based on a predetermined rule (for example, choice a is given priority over choice b, and choice b is given priority over choice c).

FIG. 6B is an exemplary view showing the display of final input findings and temporary input findings in a list format to be stored in the main memory 101 as the results of the processing in step S203, when the user (doctor) performs the input explained with reference to FIG. 6A. Since a maximum of five values can be selected in each list box shown in FIG. 6A, the temporary input finding can have the first to fifth values. Since the final input finding has only the first value, all the fields from the second to fifth values are invalid. Although a maximum of five values can be selected as the temporary input values, only two values are actually selected for each finding, so NULL is stored as the third to fifth values. It is also possible to preset two, three, or four as the maximum number of values selectable in the list box.

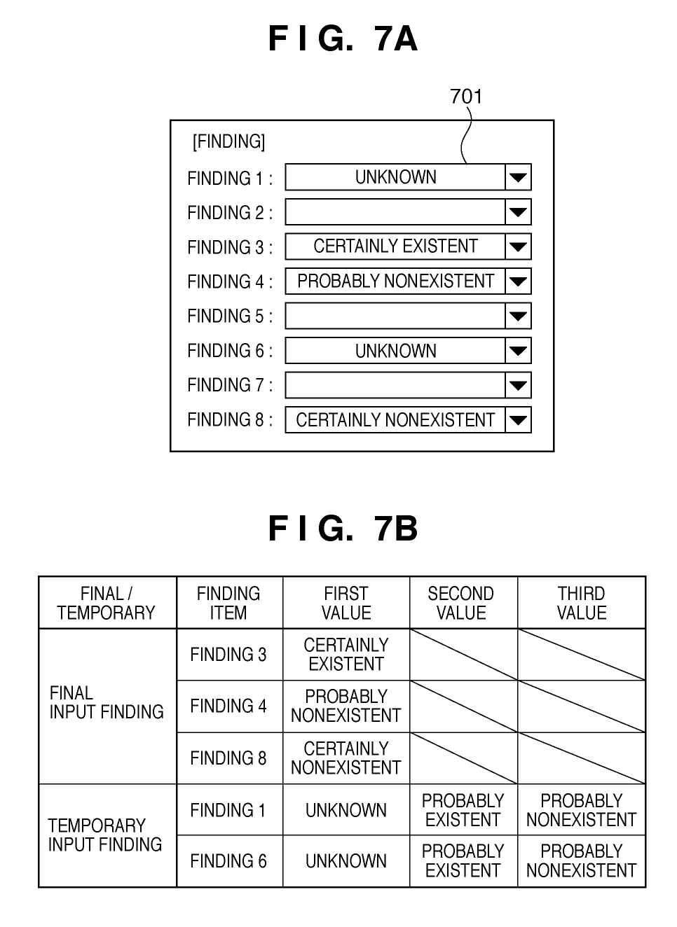

A fourth operation window example that functions as the finding temporary input means will be explained below with reference to FIG. 7A. Referring to FIG. 7A, a combo box 701 is a control for inputting a value for finding 1, and NULL is set in the initial state. This similarly applies to findings 2 to 8. Since a method of operating a combo box is generally known, an explanation of the method will be omitted.

In FIG. 7A, the user (doctor) inputs a value for only a finding presumably requiring input. In the example shown in FIG. 7A, as a possible value of each finding, it is possible to select five values “certainly existent”, “probably existent”, “unknown”, “probably nonexistent”, and “certainly nonexistent”.

The CPU 100 checks the input state of each combo box. For a finding for which a predetermined value (in the example shown in FIG. 7A, “unknown”) is input in the combo box, the CPU 100 determines that the doctor has hesitation. In this case, the CPU 100 stores, in the main memory 101, the value (“unknown”) input in the combo box and values (“probably existent” and “probably nonexistent”) before and after the input value as temporary input values. For a finding for which another value (other than “unknown”) is input in the combo box, the CPU 100 determines that the doctor has no hesitation, and stores the value input in the combo box as a final input value in the main memory 101. In the example shown in FIG. 7A, a predetermined value (“unknown”) is input for each of findings 1 and 6. Therefore, three values including the input value and the values (“probably existent” and “probably nonexistent”) before and after the input value are stored as temporary input values.

FIG. 7B is an exemplary view showing the display of final input findings and temporary input findings in a list format to be stored in the main memory 101 as the results of the processing in step S203, when the user (doctor) performs the input explained with reference to FIG. 7A. Since the final input finding has only the first value, the fields of the second and third values are invalid.

Furthermore, if the CPU 100 acquires information “finding input is complete” from the user (doctor) via a UI (not shown), the CPU 100 terminates the processing in step S203, and executes processing from step S204. FIG. 2 will be explained again below.

In step S204, the CPU 100 receives other predetermined medical information (for example, the personal information and clinical information of the patient) from the medical record database 13 across the LAN 14, and stores the received information in the main memory 101. However, this step can be omitted if no other medical information is necessary in the processing in step S205. The type of information necessary as the other medical information is prestored in the magnetic disk 102 or main memory 101.

In step S205, the CPU 100 derives a plurality of pieces of diagnosis support information by using the temporary input values of findings acquired in step S203, and the other medical information acquired in step S204. As the diagnosis support information, the CPU 100 derives, for example, a most possible diagnosis name as the diagnosis name of an abnormal lesion in a diagnosis target image. Alternatively, for each of a plurality of diagnosis names possible as the diagnosis name of the abnormal lesion in the diagnosis target image, the CPU 100 derives the probability that the diagnosis name is correct. More specifically, as diagnosis support information for a solitary abnormal lesion in the lung field of a thoracic CT image, the CPU 100 derives which of primary lung cancer, lung metastasis of cancer, and another lung disease is most possible. Alternatively, the CPU 100 derives the probability of each of primary lung cancer, lung metastasis of cancer, and another lung disease. In step S205, the CPU 100 derives one diagnosis support information for each of all combinations of the temporary input findings acquired in step S203. Note that the diagnosis support information is not limited to the above examples.

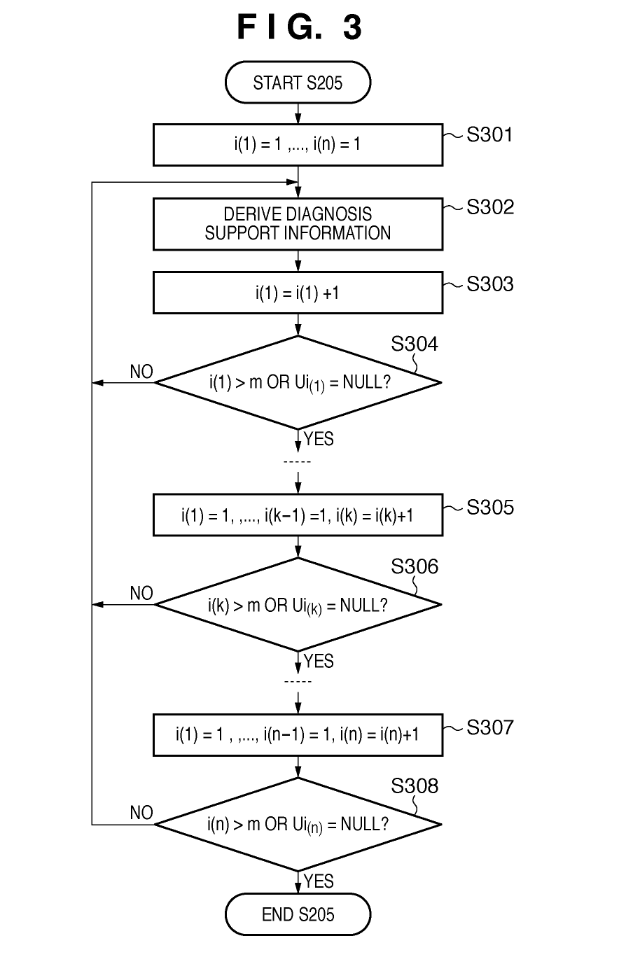

Details of the procedure in step S205 will be explained below with reference to a flowchart shown in FIG. 3. Note that FIG. 3 uses the following symbols, and the CPU 100 acquires or calculates all pieces of information indicated by the symbols, and stores them in the main memory 101.

n: the total number of temporary input findings (n≧0, n=3 in FIGS. 4B, 5B, and 6B, and n=2 in FIG. 7B)

m: the maximum number of temporary input values (m≧2, m=2 in FIG. 4B, m=3 in FIGS. 5B and 7B, and m=5 in FIG. 6B)

k: the index of a temporary input finding (k=1 to n)

i(k): the index of a temporary input value for the kth temporary input finding (i(k)=1 to m)

Ui(k): the i(k)th temporary input value for the kth temporary input finding

N: the total number of combinations of temporary input values (N≧1, N=8 in FIGS. 4B and 6B, N=18 in FIG. 5B, and N=9 in FIG. 7B)

Ej: a set of input information containing temporary input findings including a certain temporary input value group (Ui(1), Ui(2), . . . , Ui(n)), final input findings, and other medical information (j=1 to N)

OEj: diagnosis support information derived by using Ej

Note that FIG. 3 is a flowchart based on the assumption that n≧3. When n=0, step S302 need only be executed. When n=1, steps S301 to S304 need only be executed. When n=2, steps S301 to S304 and steps S307 and S308 need only be executed.

In step S301, the CPU 100 substitutes 1 in i(1) to i(n), that is, in all i(k) (k=1 to n). In step S302, the CPU 100 derives the diagnosis support information OEj based on the set Ej of the input information containing the temporary input findings including the temporary input value group (Ui(1), Ui(2), . . . , Ui(n)), the final input findings, and the other medical information.

When deriving a most possible diagnosis name as the diagnosis support information OEj, a general class classification method can be used. The class classification method is a method of inferring a class to which target data belongs, based on unique information of the target data. In this embodiment, the target data is a diagnosis target image or case, the unique information of the target data includes temporary input findings, final input findings, and other medical information, and the class to which the target data belongs is a diagnosis name. The following methods are known as examples of typical statistical classification methods, and any of these methods can be used in step S302.

### Support Vector Machine (SVM)

### Artificial Neural Network (ANN)

### Bayesian Network (BN)

### Decision Tree (DT)

k-Nearest Neighbor (kNN)

When deriving, for each of a plurality of diagnosis names, the probability that the diagnosis name is correct, as the diagnosis support information OEj, it is necessary to use an inference method capable of calculating the probability that the target data belongs to each class (diagnosis name). As inference methods like this, the above-described Bayesian Network (BN) and Artificial Neural Network (ANN) (usable as the class classification methods as well) are known, and either method can be used in step S302.

In step S303, the CPU 100 adds 1 to i(1). In step S304, the CPU 100 determines whether i(1) has exceeded m or Ui(1) is NULL. If i(1) has exceeded m or Ui(1) is NULL, the process advances to step S305; if not, the process advances to step S302.

In step S305, the CPU 100 substitutes 1 in each index from i(1) to i(k−1), and adds 1 to i(k). In step S306, the CPU 100 determines whether i(k) has exceeded m or Ui(k) is NULL. If i(k) has exceeded m or Ui(k) is NULL, the process advances to the next step; if not, the process advances to step S302.

Steps S305 and S306 are obtained by abstracting the processing when k is 2 or more and less than n. In practice, the processing in steps S305 and S306 must be performed a plurality of number of times for several values of k. For example, when n=3, the processing in steps S305 and S306 must be performed once for k=2. When n=5, the processing in steps S305 and S306 must be performed three times for k=2, 3, and 4.

In step S307, the CPU 100 substitutes 1 in each index from i(1) to i(n−1), and adds 1 to i(n). In step S308, the CPU 100 determines whether i(n) has exceeded m or Ui(n) is NULL. If i(n) has exceeded m or Ui(n) is NULL, the CPU 100 terminates the processing in step S205; if not, the process advances to step S302.

The above-mentioned process drives the diagnosis support information OEj for each of all combinations of temporary input findings (for each of which one of a plurality of temporary input values is selected).

FIG. 4C is a view showing examples of a plurality of pieces of diagnosis support information OEj derived by using the final input values and temporary input values shown in FIG. 4B. Referring to FIG. 4C, the final input values are value 4d of finding 4 and value 8e of finding 8. The temporary input values are values 1c and 1b of finding 1, values 3a and 3b of finding 3, and values 6c and 6d of finding 6. Since the three findings each have two temporary input values, the total number of combinations of the temporary input values is 2×2×2=8. For each of the eight combinations of the temporary input values, the CPU 100 derives the probabilities of diagnosis names (the probability of lung cancer, the probability of metastasis, and the probability of others) as the diagnosis support information OEj by executing step S205 described previously. In addition, the CPU 100 stores a correspondence table of the combinations of the temporary input values and the probabilities of the diagnosis names in the main memory 101. Note that the probabilities of the diagnosis names shown in FIG. 4C are dummy data formed for the explanation of this embodiment, and are obtained by intentionally selecting numerical values that clarify the changes in probability due to the differences between the temporary input values. FIG. 2 will be explained again below.

In step S206, the CPU 100 acquires an instruction to present the diagnosis support information, which is input by the user (doctor) by using the mouse 105 and keyboard 106. Normally, the doctor refers to the diagnosis support information after performing an image diagnosis, and objectively verifies his or her diagnosis. Accordingly, the diagnosis support information is presented after the instruction is received from the user (doctor). Step S206 is necessary for this purpose.

In step S207, the CPU 100 displays the diagnosis support information derived in step S205 on the monitor 104 via the display memory 103, thereby presenting the information to the user (doctor).

In step S208, the CPU 100 acquires an instruction input by the user (doctor) by using the mouse 105 and keyboard 106. Note that the instruction acquired in this step is an instruction (to be described later) to select a combination of temporary input values, or an instruction to “determine the finding”.

If it is determined in step S209 that the instruction acquired from the user (doctor) in step S208 is the instruction to “determine the finding”, the CPU 100 advances the process to step S211. On the other hand, if the instruction to select a combination of temporary input values is acquired, the CPU 100 advances the process to step S210.

In step S210, based on the user instruction acquired in step S208, the CPU 100 selects one of a plurality of temporary input values of each temporary input finding, and sets the selected temporary input value as the first value. In addition, the CPU 100 displays the selected first value on the monitor 104 via the display memory 103, thereby presenting the first value to the user (doctor). Then, the CPU 100 advances the process to step S208. That is, the user (doctor) can repetitively execute the processing in steps S208 to S210 as needed.

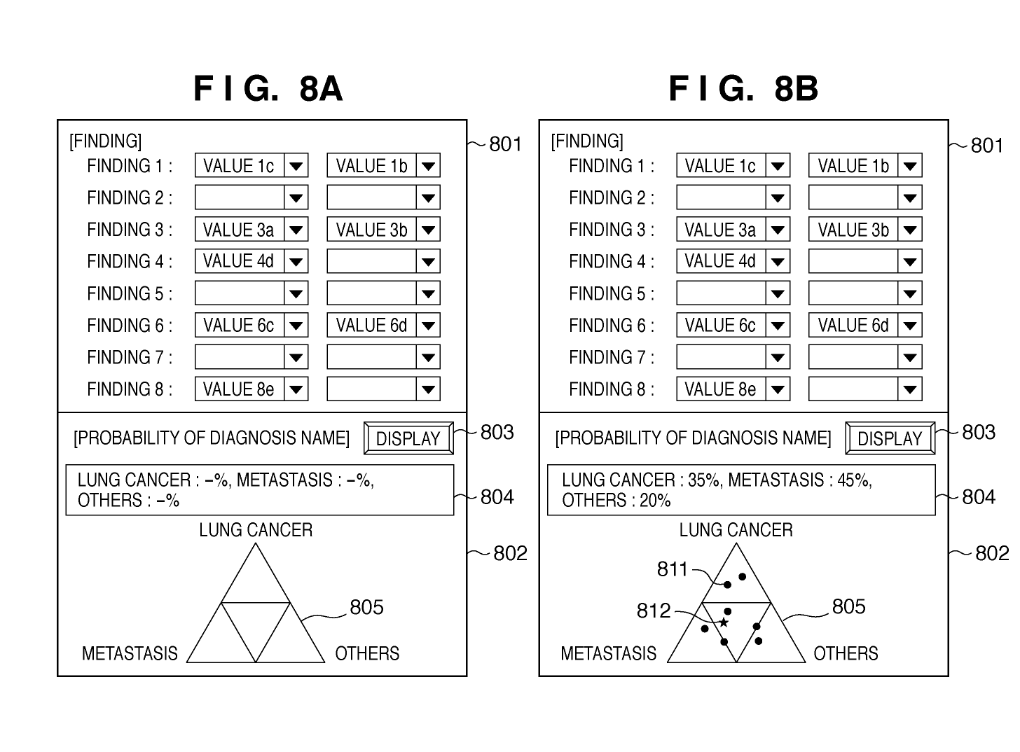

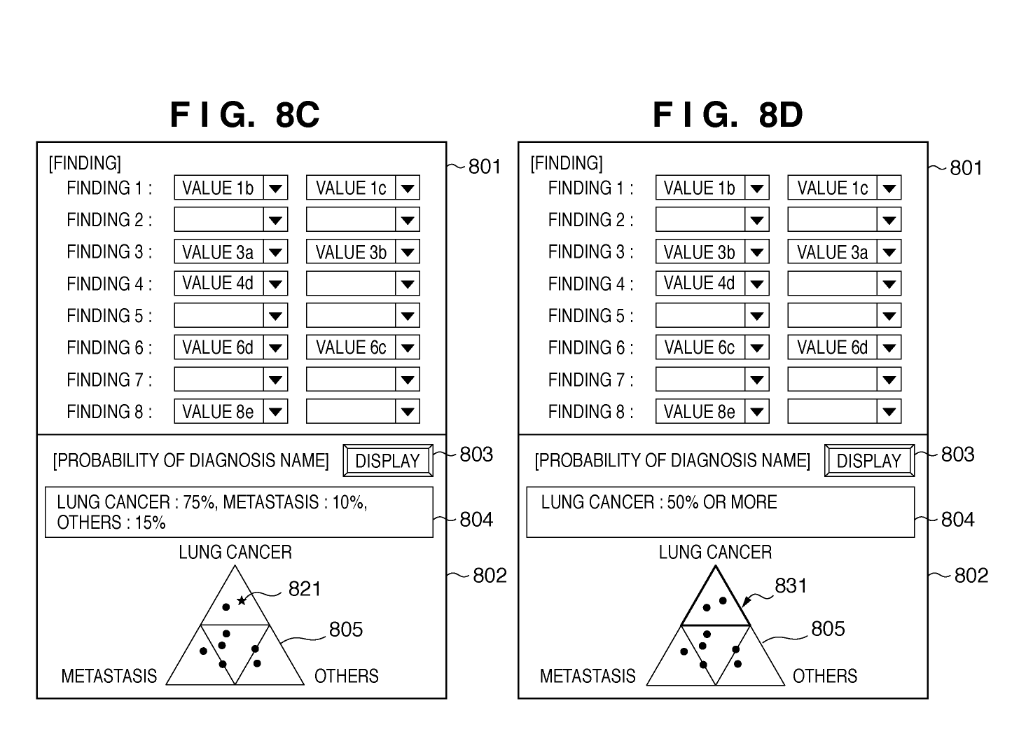

To explain the procedure of the processing in steps S206 to S210 in more detail, operation window examples to be displayed on the monitor 104 and a method of acquiring the user (doctor) instruction will be explained below with reference to FIGS. 8A to 8D. FIGS. 8A to 8D are views showing fifth to eighth operation window examples of the medical diagnosis support apparatus according to the first embodiment, and all these operation window examples basically have the same window configuration. The display contents shown in FIGS. 8A to 8D correspond to the procedure of the processing in steps S206 to S210.

FIG. 8A is an operation window example before the execution of step S206. Referring to FIG. 8A, the CPU 100 displays the finding temporary input means shown in FIG. 4A in a display range 801. However, the temporary input means as shown in FIG. 5A, 6A, or 7A can also be displayed in this portion.

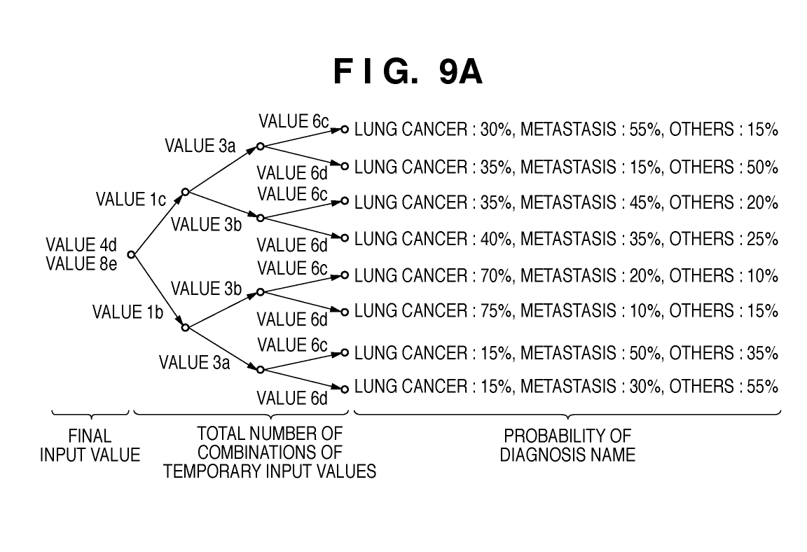

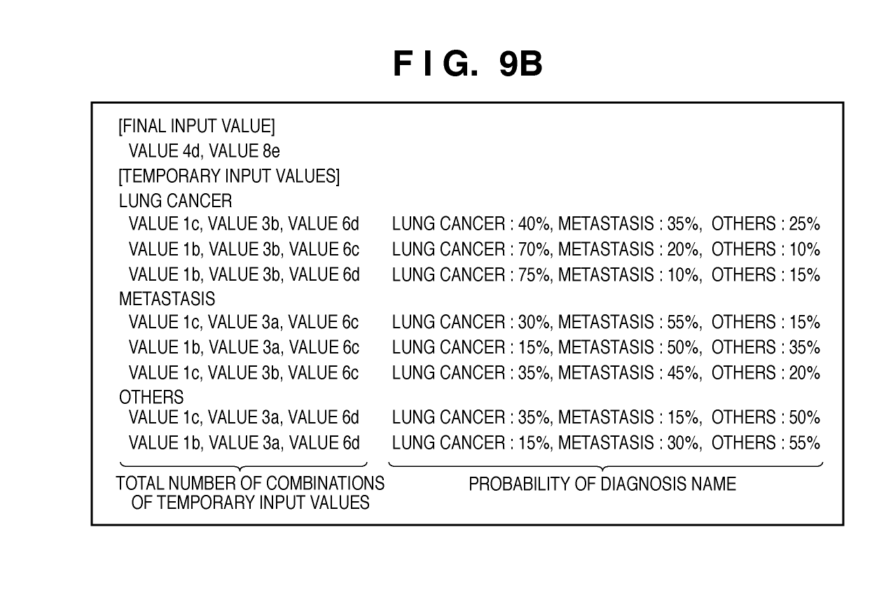

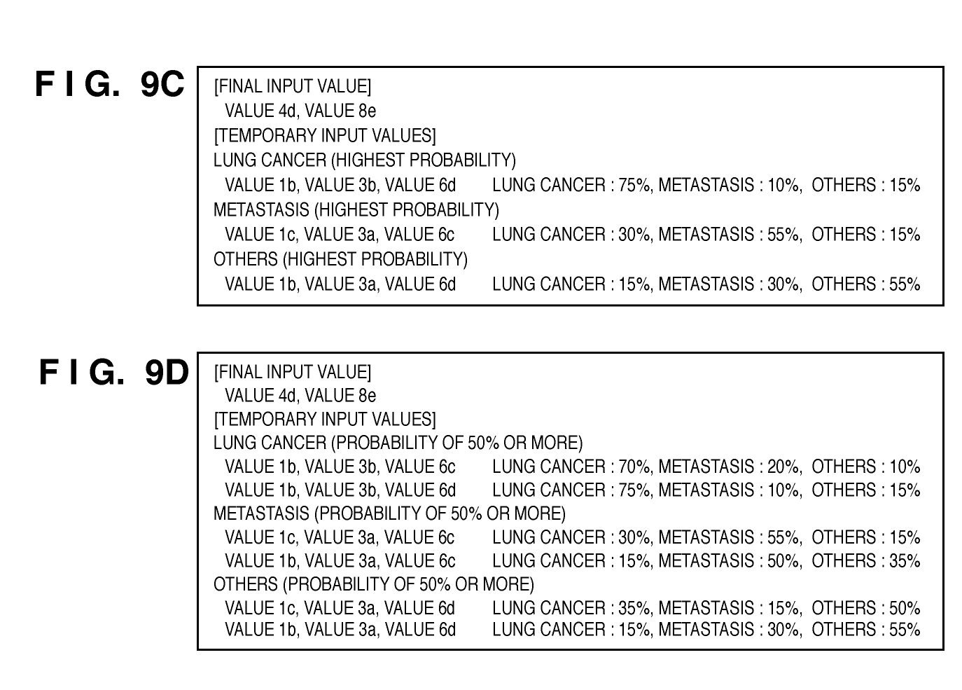

In a display range 802, the CPU 100 displays a list of the plurality of pieces of diagnosis support information OEj derived in step S205, and displays an operation window capable of an operation of selecting data on the display in a list format. However, another display method as shown in any of FIGS. 9A to 9D (to be described later) can also be displayed in this portion.

In FIG. 8A, a button 803 is a control for inputting a user instruction for displaying the list of the plurality of pieces of diagnosis support information OEj. A FIG. 805 is a special control for displaying the list of the plurality of pieces of diagnosis support information OEj, and allowing the user (doctor) to select a part of the plurality of pieces of diagnosis support information OEj. A method of using the FIG. 805 will be described later. A text box 804 is a control for displaying the probability of a diagnosis name corresponding to the diagnosis support information OEj selected by the user (doctor) by using the FIG. 805.

FIG. 8B is an operation window example that appears after the user pressed the button 803 in the operation window example shown in FIG. 8A, and is an operation window example after the execution of steps S206 and S207. Referring to FIG. 8B, a plurality of symbols “” 811 and a symbol [symbol] 812 indicate the probabilities of diagnosis names (the probability of lung cancer, the probability of metastasis, and the probability of others) with respect to the N temporary input value combinations shown in FIG. 4C. The position of the symbol “” or [symbol] in the FIG. 805 is determined in accordance with the probability of a diagnosis name (the probability of lung cancer, the probability of metastasis, or the probability of others) with respect to each temporary input value combination, so that the probability can be seen at a glance. When the symbol “” or [symbol] is positioned at an apex “lung cancer” in the FIG. 805, the probability of lung cancer is 100%. The probability of lung cancer decreases as the symbol moves away from the apex “lung cancer”. When the symbol “” or [symbol] is positioned on the bottom side (a line segment connecting an apex “metastasis” and an apex “others”) of the FIG. 805, the probability of lung cancer is 0%. This similarly applies to the probability of metastasis and the probability of others: the distance from the apex “metastasis” or “others” indicates whether the probability is high or low.

The symbol [symbol] 812 indicates the probabilities of diagnosis names when selecting the first temporary input value (a temporary input value having the highest priority order among a plurality of temporary input values) for each of all temporary input findings. The example shown in FIG. 8B indicates the probabilities of diagnosis names when selecting value 1c for finding 1, value 3a for finding 3, and value 6c for finding 6. In this state, the CPU 100 displays the probabilities of diagnosis names indicated by the symbol [symbol] 812 as a character string in the text box 804.

FIG. 8C is an operation window example that appears after the user selected one of the plurality of symbols “”, and is an operation window example after the execution of steps S208 to S210.

When the user selects one of the symbols “” in FIG. 8B, the CPU 100 changes the selected symbol “” into the symbol [symbol] , and changes the former symbol [symbol] into the symbol “”. Accordingly, the symbol [symbol] is displayed in only the position selected by the user. FIG. 8C shows that a symbol [symbol] 821 is selected. In this state, the CPU 100 displays the probabilities of diagnosis names indicated by the symbol [symbol] 821 as a character string in the text box 804.

Furthermore, the CPU 100 checks temporary input value combinations corresponding to the probabilities of diagnosis names indicated by the symbol [symbol] 821, by referring to the correspondence table of the temporary input value combinations and diagnosis name probabilities explained with reference to FIG. 4C. The CPU 100 sets the found temporary input value combination (selected by the user) as the first value of each finding, and presents the value in the display range 801. For example, when using the temporary input means shown in FIG. 4A, the CPU 100 compares the found temporary input value combination with the first value of each combo box shown in the display range 801. If the found temporary input value is not the first value, the CPU 100 replaces the first and second values with each other, and reflects the changed first and second values on the display of combo boxes. In the example shown in FIG. 8C, the user has selected “lung cancer: 75%, metastasis: 10%, and others: 15%” as the probabilities of diagnosis names. Therefore, the CPU 100 checks the corresponding temporary input value combinations, and obtains values 1b, 3b, and 6d. The CPU 100 then replaces the values in each combo box with each other such that each of values 1b, 3b, and 6d is the first value (a temporary input value having the highest priority order among a plurality of temporary input values) of a corresponding one of findings 1, 3, and 6.

FIG. 8D is an operation window example that appears after the user selected one of four figures “Δ” in the FIG. 805 in the operation window example shown in FIG. 8B, and is an operation window example after the execution of steps S208 to S210. When the user selects one of the figures “Δ” in FIG. 8B, the CPU 100 highlights the selected figure “Δ”, and changes the former symbol [symbol] into the symbol “”. Alternatively, if a highlighted figure “Δ” already exists, the CPU 100 returns the figure “Δ” to the normal display. That is, only the figure “Δ” selected by the user is highlighted, and no symbol [symbol] is displayed. FIG. 8D shows that a figure “Δ” 831 is selected, and the figure “Δ” 831 indicates the range within which the probability of lung cancer is 50% or more. In this state, the CPU 100 displays the probability of a diagnosis name (the probability of lung cancer is 50% or more) indicated by the figure “Δ” 831 as a character string in the text box 804.

Furthermore, the CPU 100 checks all temporary input value combinations corresponding to the probability of a diagnosis name (the probability of lung cancer is 50% or more) indicated by the figure “Δ” 831, by referring to the correspondence table of the temporary input value combinations and diagnosis name probabilities explained with reference to FIG. 4C. In the example shown in FIG. 4C, temporary input value combinations for which the probability of lung cancer is 50% or more are a combination of values 1b, 3b, and 6c, and a combination of values 1b, 3b, and 6d. In addition, the CPU 100 checks common portions of the temporary input value combinations for which the probability of lung cancer is 50% or more. In the above-mentioned example, the common portions are values 1b and 3b. The CPU 100 then compares the found common portions with the first value of each combo box shown in the display range 801. If the first value is not either of the found common portions, the CPU 100 replaces the first and second values with each other, and reflects the changed first and second values on the display of combo boxes. In the example shown in FIG. 8D, the user has selected “the probability of lung cancer is 50% or more” as the diagnosis probability. Therefore, the CPU 100 sets values 1b and 3b that are the common portions of the corresponding input value combinations, as the first values in the combo boxes of findings 1 and 3, respectively. The CPU 100 does not change the values of the combo boxes of finding 6 because these values are irrelevant to “the probability of lung cancer is 50% or more”. That is, the condition “the probability of lung cancer is 50% or more” is satisfied regardless of whether value 6c or 6d is selected as finding 6. Accordingly, either temporary input value can be the first value of finding 6.

It is also possible to use the rule that the first value of temporary input values of a finding (finding 6) not included in the common portions is returned to the state before the execution of step S206 shown in FIG. 8A. This is so because a temporary input value (value 6c) initially selected as the first value by the user is perhaps more certain than a temporary input value (value 6d) selected as the second value.

FIGS. 9A to 9D illustrate examples of other display methods (operation windows) replacing the FIG. 805 explained with reference to FIG. 8A.

An example of a first display method (operation window) replacing the FIG. 805 will be explained below with reference to FIG. 9A. The CPU 100 displays, by using a tree structure, a list of the plurality of pieces of diagnosis support information OEj derived in step S205. The user can obtain the same result as when selecting the symbol “” in the FIG. 805, by selecting one of the probabilities of diagnosis names displayed at the ends of the tree structure. That is, the CPU 100 displays the selected diagnosis name probability as a character string in the text box 804. Also, the CPU 100 sets a temporary input value combination corresponding to the selected diagnosis name probability as the first value of each finding, and reflects this change on the display of each combo box in the display range 801.

An example of a second display method (operation window) replacing the FIG. 805 will be explained below with reference to FIG. 9B. The CPU 100 displays the plurality of pieces of diagnosis support information OEj derived in step S205, as a list in which diagnosis names having relatively high probabilities are classified (grouped). The user can obtain the same result as when selecting the symbol “” in the FIG. 805, by selecting one of rows (indicating the probabilities of diagnosis names) shown in the list. Note that when only a diagnosis name having the highest possibility is derived as the diagnosis support information OEj in the processing in step S205, the display method shown in FIG. 9B in which combinations of temporary input values are displayed as they are classified for each diagnosis name is suitable. In this case, however, no probability is displayed.

An example of a third display method (operation window) replacing the FIG. 805 will be explained below with reference to FIG. 9C. The CPU 100 selects a temporary input value combination having the highest probability for each diagnosis name from the list shown in FIG. 9B, and displays the selection results as a list. The user can obtain the same result as when selecting the symbol “” in the FIG. 805, by selecting one of rows (indicating the probabilities of diagnosis names) shown in the list.

An example of a fourth display method (operation window) replacing the FIG. 805 will be explained below with reference to FIG. 9D. The CPU 100 selects a temporary input value combination having a probability of 50% for each diagnosis name from the list shown in FIG. 9B, and displays the selection results as a list. The user can obtain the same result as when selecting the symbol “” in the FIG. 805, by selecting one of rows (indicating the probabilities of diagnosis names) shown in the list.

The processing in steps S206 to S210 is executed as described above.

In step S211, the CPU 100 determines the first value (a temporary input value having the highest priority order among a plurality of temporary input values) of each temporary input finding selected in the processing up to step S210, as a final input value of the temporary input finding, and determines the temporary input finding as a final input finding. Then, the CPU 100 stores information concerning the findings obtained as described above in the magnetic disk 102. Also, in accordance with an instruction from the user (doctor), the CPU 100 prints the information concerning the findings by using a printer (not shown) or the like. Alternatively, in accordance with an instruction from the user (doctor), the CPU 100 transmits the information concerning the findings to a server (for example, an RIS (Radiology Information System) or finding server) (not shown) across the LAN 14. After that, the CPU 100 terminates the process of the flowchart shown in FIG. 2.

As described above, finding input using the medical diagnosis support apparatus according to this embodiment is implemented. The medical diagnosis support apparatus according to this embodiment allows the user (doctor) to simultaneously temporarily input a plurality of values for a finding item which he or she hesitates to judge, and readily understand the influence of each temporary input value on diagnosis support information in the form of a list. In addition, one of the temporary input values can immediately be changed into a final input value by selecting one of a plurality of pieces of presented diagnosis support information. This effectively makes easy selection of an optimum finding feasible.

In the embodiment of the present invention, the user (doctor) can simultaneously temporarily input a plurality of values for a finding item which he or she hesitates to judge, and readily understand the influence of each temporary input value on diagnosis support information in the form of a list. Accordingly, the user (doctor) can determine an optimum value of the finding item by an efficient method capable of reducing errors.

Also, in the embodiment of the present invention, one of a plurality of temporary input values can be changed into a final input value by selecting one of a plurality of pieces of presented diagnosis support information. This makes extremely easy selection of an optimum value possible.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-186153, filed Aug. 10, 2009, which is hereby incorporated by reference herein in its entirety.

1. A medical diagnosis support apparatus comprising:
item display means for displaying, on display means, a plurality of items for which a parameter for deriving diagnosis support information can be input;
temporary input means configured to input a plurality of different values as temporary input values for the plurality of items displayed by said item display means;
deriving means for deriving, by referring to medical information, a plurality of pieces of diagnosis support information each corresponding to one of combinations of the plurality of different temporary input values input by said temporary input means; and
presenting means for presenting, on said display means, the plurality of pieces of diagnosis support information derived by said deriving means, together with the display of the plurality of items, in a list format.

2. The apparatus according to claim 1, further comprising selecting means for selecting one of the plurality of pieces of diagnosis support information displayed in the list format,
wherein said temporary input means sets a temporary input value corresponding to the diagnosis support information selected by said selecting means, as a first temporary input value having a highest priority order among the plurality of different temporary input values.

3. The apparatus according to claim 2, further comprising determining means for determining the first temporary input value set by said temporary input means, as a final input value for determining one of the plurality of pieces of diagnosis support information.

4. A method of controlling a medical diagnosis support apparatus, comprising:
an item display step of displaying, on display means, a plurality of items for which a parameter for deriving diagnosis support information can be input;
a temporary input step of accepting a plurality of different values input as temporary input values for the plurality of items displayed in the item display step;
a deriving step of deriving, by referring to medical information, a plurality of pieces of diagnosis support information each corresponding to one of combinations of the plurality of different temporary input values input in the temporary input step; and
a presenting step of presenting, on the display means, the plurality of pieces of diagnosis support information derived in the deriving step, together with the display of the plurality of items, in a list format.

5. A program which is stored in a computer-readable storage medium, and causes a computer to function as a medical diagnosis support apparatus cited in claim 1.
